(19) United States
(12) Patent Application Publication
(10) Pub. No.: US 2009/0086244 A1
(43) Pub. Date: Apr. 2, 2009

(54) IMAGE FORMING APPARATUS

(75) Inventor: Masato Matoba, Tokyo (JP)

Correspondence Address: SONNENSCHEIN NATH & ROSENTHAL LLP, P.O. BOX 061080, WACKER DRIVE STATION, SEARS TOWER, CHICAGO, IL, 60606-1080, US

(73) Assignee: SONY CORPORATION, Tokyo (JP)

(21) Appl. No.: 12/233,708

(22) Filed: Sep. 19, 2008

(30) Foreign Application Priority Data
Sep. 28, 2007 (JP) 2007-254726

(51) Int. Cl. G06F 3/12

(52) U.S. Cl. 358/1.13

(57) ABSTRACT

An image forming apparatus includes the following elements. An image data reading unit reads image data stored in a storage medium. An image forming unit forms an image on a recording medium on the basis of the read image data. A billing information generating unit charges a fee for the number of formed images. A test-indication adding unit adds test-indication data indicating a test image to the read image data. A test-print production instructing units instructs the image forming unit to form a test image on the basis of the image data with the test-indication data being added thereto. The billing information generating unit is configured to charge no fee when a test image is formed in response to an instruction provided by the test-print production instructing unit.

### CROSS REFERENCES TO RELATED APPLICATIONS

The present invention contains subject matter related to Japanese Patent Application JP 2007-254726 filed in the Japanese Patent Office on Sep. 28, 2007, the entire contents of which are incorporated herein by reference.

### BACKGROUND OF THE INVENTION

1. Field of the Invention

The present invention relates to an image forming apparatus including an image data reading unit configured to read image data stored in a storage medium, an image forming unit capable of forming an image on a recording medium on the basis of the image data read by the image data reading unit, and a billing information generating unit configured to charge a fee for the number of images formed by the image forming unit. More specifically, the present invention relates to a technique that allows a user of an image forming apparatus to review with certainty images that will be formed.

2. Description of the Related Art

Nowadays, various image forming apparatuses are becoming increasingly widely used. Printers, which are image forming apparatuses, have increased compactness and performance, and are being placed in all locations. In particular, dye-sublimation color printers ensure production of high-quality prints, and therefore have been often utilized to provide printing services for commercial purposes such as parties and sporting events, and to provide printing services at public places such as amusement parks and tourist facilities, and have even been designed for professional use such as in printing shops. Such professional color printers provide various services, and kiosk-based printing systems (hereinafter referred to as “printing kiosk apparatuses”) connected to reception terminals have been available.

A printing kiosk apparatus is a self-service image forming apparatus that is operated by a user to form (or print) an image from his or her own image data, and is provided with a memory card slot and a color liquid crystal display for displaying image data stored in a memory card. When a user inserts a memory card carried by the user into the memory card slot, image data stored in the memory card is read, and preview images of the image data are displayed on the color liquid crystal display. The user can select an image that is desired to be printed from among the preview images.

In this state, the user selects an image that is desired to be printed and specifies the number of prints of the image. Thus, after the user pays a fee for the specified number of prints, the selected image is printed on sheets of printing paper to produce color prints, and the prints are output as photographs one by one from a color printer provided in the printing kiosk apparatus. The user views the preview images displayed on the color liquid crystal display and can envisage how the printed images will look. Then, the user selects only an image that is desired to be printed and executes color printing to thereby obtain a print (or photograph) of the selected image.

In some cases, the user may desire to correct the color tone of the selected image or to add text to the image before printing the image. In such cases, the user can adjust the image quality of the image or can edit the image while viewing the preview images displayed on the color liquid crystal display. The result is then reflected in the preview images. Thus, the user can, after reviewing the quality-adjusted or edited image on the color liquid crystal display, obtain a photograph of a desired image once he or she pays a fee therefor.

In actuality, however, a color print of an image (or a photograph) that is produced on the basis of an image displayed on the color liquid crystal display may be different from that expected by the user. Due to reasons such as display processing performed on the preview images, the difference in color characteristics between the color liquid crystal display and the color printer, and other characteristics of the color printer, an image displayed on the color liquid crystal display and a color print of the image may differ in color tone, or a portion of the image displayed on the color liquid crystal display may be cut off and a color print of the image, a portion of which has been cut off, may be produced.

Therefore, in a situation where the print result may not necessarily be obtained as expected by a user, relying on only the preview images displayed on the color liquid crystal display and paying a fee for the number of prints to be produced may be risky for users in view of the possibility that they might not obtain their print results as desired. The increasing utilization of such printing kiosk apparatuses due to the prevalence of digital cameras has caused a problem in that a print result that does not match user expectation may be obtained.

A technique for providing test printing has been available. For example, Japanese Unexamined Patent Application Publication No. 2004-159059 discloses a test print producing method that allows quick and reliable determination of image processing conditions for correcting a read image, in which the cost of printing can be reduced.

Japanese Unexamined Patent Application Publication No. 2002-209090 discloses a test print producing method that allows a reduction in the amount of printing paper used for test printing and that allows the determination of the most appropriate combination of image processing conditions and an improvement in the processing efficiency in producing a high-quality print.

### SUMMARY OF THE INVENTION

In the techniques disclosed in Japanese Unexamined Patent Application Publication Nos. 2004-159059 and 2002-209090, the cost of printing or the amount of printing paper used for test printing can be reduced. However, a fee for the number of prints including test prints is still charged. Even if the print result can be obtained, as expected by a user, using a reduced amount of printing paper, the user is charged for the fee every time a test print is executed.

It is therefore desirable to allows a user to review with certainty a print result, by executing a test print (by forming a test image), so that the user can obtain the print result as expected without charging the user a fee.

According to an embodiment of the present invention, an image forming apparatus includes image data reading means for reading image data stored in a storage medium; image forming means capable of forming an image on a recording medium on the basis of the image data read by the image data reading means; billing information generating means for charging a fee for the number of images that have been formed by the image forming means; test-indication adding means for adding test-indication data indicating a test image to the image data read by the image data reading means; and test-print production instructing means for instructing the image forming means to form a test image on the basis of the image data to which the test-indication data has been added by the test-indication adding means. The billing information generating means is configured to charge no fee when a test image is formed in response to an instruction provided by the test-print production instructing means.

The image forming apparatus includes billing information generating means for charging a fee for the number of images (the number of prints) that have been formed by image forming means. The image forming apparatus further includes test-indication adding means for adding test-indication data indicating a test print (a test image) to image data read by image data reading means, and test-print production instructing means for instructing the image forming means to form a test image on the basis of the image data to which the test-indication data has been added by the test-indication adding means. The billing information generating means charges no fee when a test print is executed (a test image is formed) in response to an instruction provided by the test-print production instructing means. Once a user executes a test print, an indication (a test indication) that a test print was made is added to an image. However, the user is not charged for the test print.

Accordingly, a user can execute a test print (form a test image). However, the user is not charged for the test print. The execution of a test print in advance allows the user to review with certainty a print result without being charged for the test print. The user can therefore obtain the print result as expected.

### BRIEF DESCRIPTION OF THE DRAWINGS

FIG. 1 is an external perspective view of a printing kiosk apparatus according to an embodiment of the present invention;

FIG. 2 is a block diagram showing an example structure of the printing kiosk apparatus according to the present embodiment;

FIG. 3 is a diagram showing a test-print setting screen provided by the printing kiosk apparatus according to the present embodiment;

FIG. 4 is a diagram showing a user operation provided by the printing kiosk apparatus according to the present embodiment;

FIG. 5 is a flowchart showing the flow of a printing process for producing a test print using the printing kiosk apparatus according to the present embodiment; and

FIGS. 6A and 6B are diagrams showing a test print and a normal print, respectively, which are produced using the printing kiosk apparatus according to the present embodiment.

### DESCRIPTION OF THE PREFERRED EMBODIMENTS

An embodiment of the present invention will be described with reference to the drawings.

In the following embodiment, an image forming apparatus according to an embodiment of the present invention will be described in the context of a printing kiosk apparatus 10 in a digital photo printing system, which is configured to read image data from a memory card (which may correspond to a storage medium according to an embodiment of the present invention) carried by a user and to print an image selected according to an instruction given by the user onto printing paper (which may correspond to a recording medium according to an embodiment of the present invention) using a printer 40 (which may correspond to image forming means according to an embodiment of the present invention).

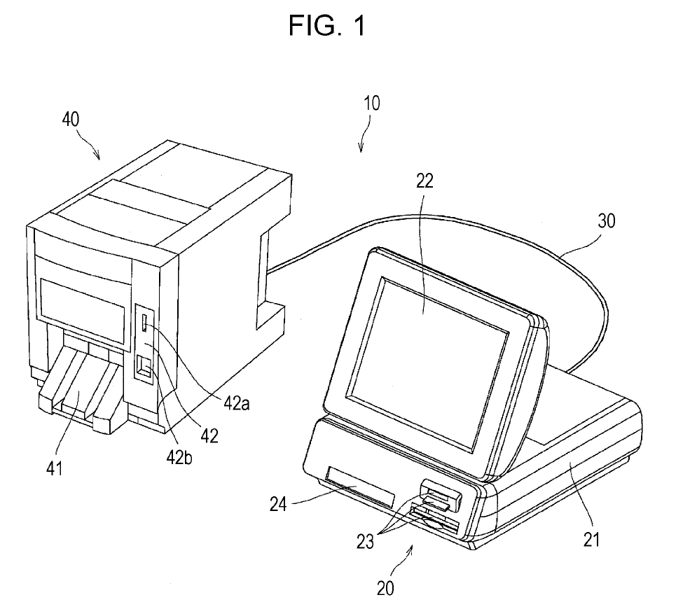

FIG. 1 is an external perspective view of the printing kiosk apparatus 10 of the present embodiment.

As shown in FIG. 1, the printing kiosk apparatus 10 of the present embodiment includes an operation terminal 20 operable by a user, and the printer 40 connected to the operation terminal 20 using a cable 30.

The operation terminal 20 has a box-shaped housing 21. A color liquid crystal display 22 (which may correspond to image displaying means according to an embodiment of the present invention) is provided on a front upper portion of the housing 21. The color liquid crystal display 22 has, in addition to a function of displaying various messages or images, a touch panel function capable of receiving an instruction given by the user, as necessary.

Three memory card slots 23 (which may correspond to image data reading means according to an embodiment of the present invention) that support different standards or sizes of memory cards are provided on a front center portion of the housing 21. The user can directly insert different types of memory cards carried by the user into the memory card slots 23 supporting the standard or the like of the individual memory cards without using an adapter. When a memory card is inserted into one of the memory card slots 23, image data stored in the memory card is read.

A compact disk (CD) drive 24 (which may correspond to image data reading means according to an embodiment of the present invention) is further provided on the front center portion of the housing 21 so that a disk-shaped optical-read storage medium, such as a CD-Recordable (CD-R) (which may correspond to a storage medium according to an embodiment of the present invention), besides a card-shaped semiconductor storage medium such as a memory card, can be used. When the user inserts his or her CD-R into the CD drive 24, image data recorded on the CD-R is read. In place of the CD drive 24, any other drive such as a digital versatile disk (DVD) drive or a Blu-ray disc® (BD) drive may be provided.

The printer 40 may be a dye-sublimation color printer configured to sublimate a dye applied to an ink ribbon by heat energy generated by a thermal head located in the printer 40 and to transfer the dye onto rolled printing paper to produce a print. The printing paper having an image formed thereon is cut according to a print size (such as L size (89 mm×127 mm), KG size (102 mm×152 mm), 2L size (127 mm×178 mm), or panorama size (89 mm×254 mm)) to produce prints, and the prints are discharged as photographs one by one from a paper outlet 41.

The printer 40 is also provided with an accounting device 42 (which may correspond to billing information generating means according to an embodiment of the present invention). The accounting device 42 is configured to charge a fee for the number of images to be formed on printing paper (the number of cut sheets of paper to be discharged as photographs). The accounting device 42 includes a coin insertion slot 42a and a coin return slot 42b.

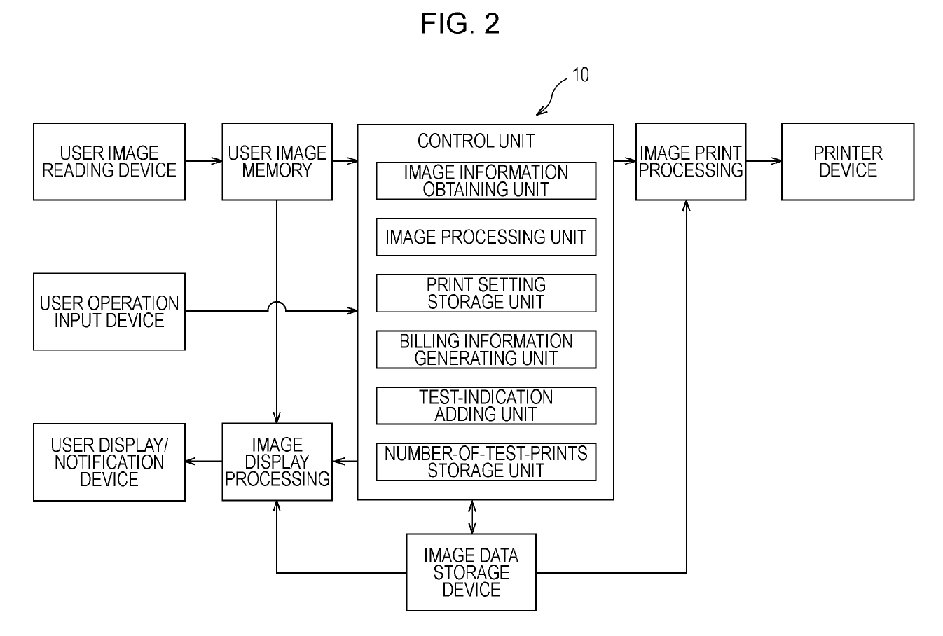

FIG. 2 is a block diagram showing an example structure of the printing kiosk apparatus 10 of the present embodiment.

As shown in FIG. 2, the printing kiosk apparatus 10 includes a control unit that executes calculations on various types of input and output data and that controls the input and output operations. The control unit is connected to a user image reading device (which may correspond to image data reading means according to an embodiment of the present invention), a user operation input device (which may correspond to test-print production instructing means, test-print production setting means, and test-indication-position setting means according to an embodiment of the present invention), a user display/notification device (which may correspond to image displaying means according to an embodiment of the present invention), a printer device (which may correspond to image forming means according to an embodiment of the present invention), and an image data storage device.

The control unit is configured to control the overall operation of the printing kiosk apparatus 10 according to printing application software, and includes, for example, a central processing unit (CPU) that performs calculations, a read-only memory (ROM) storing the printing application software, and a random access memory (RAM) temporarily storing image data and the like. The control unit functions as an image information obtaining unit, an image processing unit, a print setting storage unit, a billing information generating unit, a test-indication adding unit, and a number-of-test-prints storage unit, which are described below, to execute various control operations associated with functions such as input and output functions, a management function, and a printing function.

The user image reading device is connected on the input side of the control unit to input image data owned by the user to the control unit, and may specifically be implemented by the memory card slots 23 and CD drive 24 shown in FIG. 1. For example, when a memory card carried by the user is inserted into one of the memory card slots 23, image data stored in the memory card is read by the user image reading device (in this case, the one memory card slot 23). The read image data is stored in a user image memory connected between the user image reading device and the control unit. The image information obtaining unit of the control unit analyzes the image data stored in the user image memory, and obtains various types of image information included in the image data (such as Exchangeable Image File Format (EXIF) information, file information, and image data numbers to be retrieved).

The image data storage device is connected to the control unit for auxiliary use such as for the excess of the storage capacity of the user image memory which may occur when the user brings a plurality of memory cards, and may specifically be implemented by a hard disk drive (not shown) having a large storage capacity. The hard disk drive is connected internally or externally to the printing kiosk apparatus 10. A large amount of image data read from the memory cards is collectively stored in the hard disk drive. The image data stored in the user image memory or image data storage device is subjected to image display processing by the control unit, and is then displayed as preview images on the user display/notification device (specifically, the color liquid crystal display 22 shown in FIG. 1). The user display/notification device may be implemented by any display other than the color liquid crystal display 22, such as a flat panel display or a cathode ray tube (CRT) display.

The user operation input device is connected on the input side of the control unit to input various instructions corresponding to operations given by the user (such as an instruction to select an image, an instruction to produce a print (hereinafter referred to as a “print instruction”), an instruction to produce a test print (hereinafter referred to as a “test-print instruction”), and an instruction to edit an image) to the control unit. Specifically, the user operation input device may correspond to the touch panel function of the color liquid crystal display 22 shown in FIG. 1. As described below, the user operates (or touches) a “select” button displayed on the color liquid crystal display 22 to give an instruction to select an image to be printed, and operates (or touches) other buttons such as an OK button (print button), a “test print” button, and an “adjust color” button to perform operations such as issuing a print instruction, issuing a test-print instruction (an instruction to form a test image), and issuing an instruction to execute editing. The user operation input device may be provided separately from the color liquid crystal display 22, and may include a push button switch, a keyboard, and a pointing device.

The printer device is connected on the output side of the control unit, and may specifically be implemented by the printer 40 shown in FIG. 1. When the user selects an image and gives an instruction to print the selected image, the selected image is subjected to image print processing by the control unit, and is then printed using the printer 40. Print data necessary for performing printing (for example, editing data or image data) is stored in the print setting storage unit of the control unit. When the user gives a print instruction (including instructions on the number of prints and the print size) according to an operation screen or a guidance of the user operation input device, the selected image, which is stored in the print setting storage unit, is subjected to image processing for printing, and is then printed using the printer 40. The billing information generating unit of the control unit generates billing information for charging a fee for the number of prints.

Similarly, when an instruction to produce a test print of the selected image is given, the image stored in the print setting storage unit of the control unit is subjected to image print processing, and is then printed using the printer 40. Thus, the user gives a test-print instruction, thereby obtaining a print, which is the same as a print produced in response to a print instruction.

It is noted that the test-print instruction is restrictively permitted. That is, when the maximum number of test prints allowed to be produced, which is designated by test-print production setting means according to an embodiment of the present invention, which will be described below, has been reached, a subsequent test-print instruction is discarded. The designated maximum number of test prints is stored in the number-of-test-prints storage unit of the control unit. On the user display/notification device (the color liquid crystal display 22), the number of produced test prints (or the number of formed test images) and the remaining number of test prints to be produced are displayed. The remaining number of test prints to be produced is determined by subtracting the number of produced test prints from the number of test-print instructions that have been made.

In the case of printing in response to a test-print instruction, in order to indicate that a test print was made, the test-indication adding unit of the control unit adds test-indication data (for example, test data “SAMPLE”) to the image data according to an adding position, indicating a position at which the test-indication data is to be added, which is designated by test-indication-position setting means according to an embodiment of the present invention, which will be described below. In this case, the billing information generating unit of the control unit does not generate billing information for charging a fee, and there is no charge to the user. Instead of not generating billing information, the billing information generating unit may generate billing information indicating a free-of-charge service.

In a case where a user gives an instruction to edit an image such as adjustment of the color tone thereof, the image processing unit of the control unit performs image processing, and the edited image is stored in the print setting storage unit of the control unit. The edited image is subjected to image display processing, and is then displayed on the user display/notification device (the color liquid crystal display 22). Thus, the user can review a preview image in which the edited image is reflected. The edited image can be printed in response to a print instruction or a test-print instruction.

Accordingly, the user first executes test printing, thereby reviewing with certainty an image that will be formed, including an edited image, and can therefore obtain a print result as he or she expected. In the case of producing a test print, there is no charge for the test print although an indication that a test print was made is given. Therefore, the user incurs no cost.

The details of such test printing will now be described.

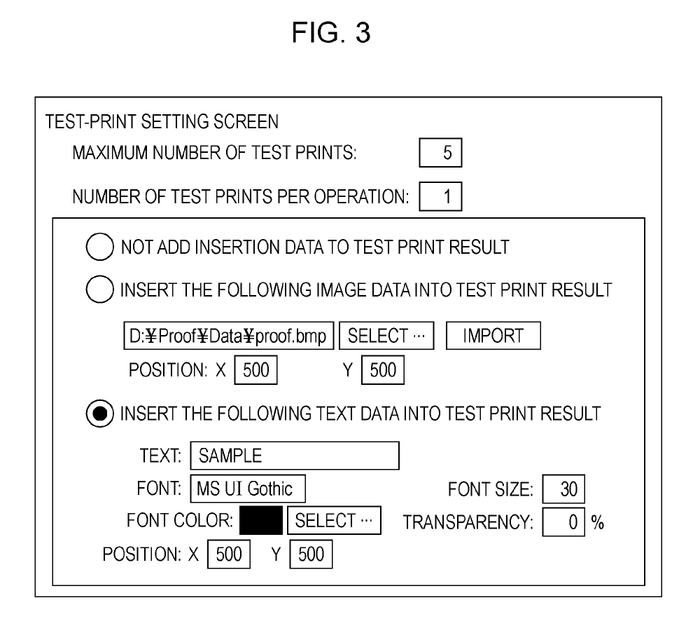

FIG. 3 is a diagram showing a test-print setting screen provided by the printing kiosk apparatus 10 of the present embodiment.

Test-print setting items shown in FIG. 3 are displayed on the color liquid crystal display 22 (see FIG. 1) according to the print application software of the control unit shown in FIG. 2. As shown in FIG. 3, the setting items include an item indicating the maximum number of test prints allowed to be produced (“maximum number of test prints”), and an item indicating the number of test prints to be produced per operation (“number of test prints per operation”). The “maximum number of test prints” and “number of test prints per operation” specified on the test-print setting screen are stored in the number-of-test-prints storage unit shown in FIG. 2.

The setting items further include an item indicating whether or not to add insertion data to a test print result (the user can toggle the setting on or off). The insertion data is test-indication data based on image data or text data for indicating a test print. The setting items further include an item indicating the selection and import of image data to be inserted in a test print result, and an item indicating settings of text data to be inserted in a test print result (including text, font type, font size, font color, and transparency). The display positions of the image data and text data to be inserted in a test print result may be determined by determining “position X” and “position Y” to specify the X coordinates and Y coordinates.

Thus, setting items for test printing are displayed on the color liquid crystal display 22 (see FIG. 1). Since the color liquid crystal display 22 has a touch panel function, the test-print setting screen shown in FIG. 3 serves as test-print production setting means and test-indication-position setting means according to an embodiment of the present invention. Of the setting items shown in FIG. 3, the setting of the “maximum number of test prints” corresponds to the test-print production setting means, and the setting of the “position X” and “position Y” (to specify the X and Y coordinates) of image data and text data to be inserted in a test print result corresponds to the test-indication-position setting means. Those settings are made primarily by an owner of the printing kiosk apparatus 10 rather than by the user.

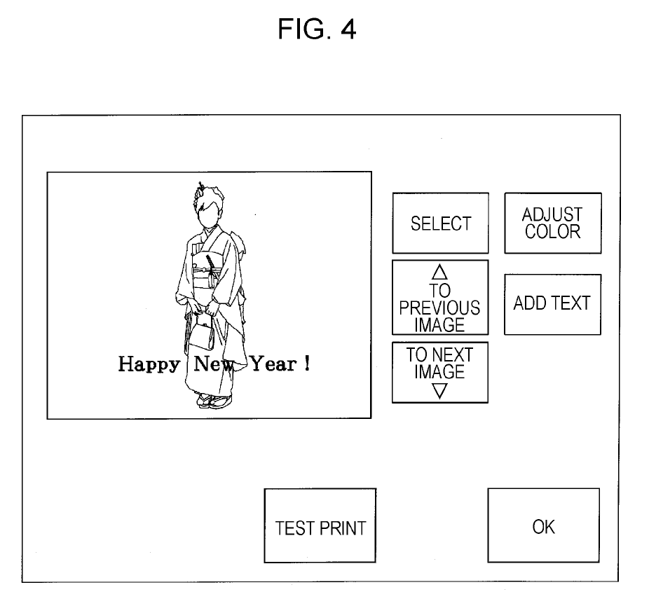

FIG. 4 is a diagram showing a user operation screen provided by the printing kiosk apparatus 10 of the present embodiment.

The user operation screen shown in FIG. 4 is displayed on the color liquid crystal display 22 (see FIG. 1). The user operation screen has a relatively large display area for displaying a preview image, and an image owned by the user is displayed in the display area according to the print application software of the control unit shown in FIG. 2. Thus, the user can review a print result, which will be obtained by the user, as an image on the user operation screen shown in FIG. 4.

The user operation screen further includes, outside the display area for displaying a preview image, a “select” button for selecting an image, a “to previous image” button for returning the current preview image to the previous image, a “to next image” button for displaying a subsequent image, an “adjust color” button for changing the color tone of the image to edit the image, an “add text” button for adding text to the image, a “test print” button for issuing a test-print instruction, and an “OK” button for issuing a non-test-print instruction or a normal print instruction. Those buttons are displayed according to the print application software of the control unit shown in FIG. 2. The buttons described above are merely examples, and additional buttons may be provided.

Since the color liquid crystal display 22 has a touch panel function, the user touches any of the buttons described above, thereby performing an operation associated with the touched button. If the user touches the “to previous image” button or the “to next image” button and then touches the “select” button when a desired preview image is being displayed, the preview image is selected as a subject image to be printed.

By touching the “adjust color” button, the user is enabled to issue an instruction to edit the preview image (the subject image). Thus, the user can adjust the color tone or the like of the preview image while viewing the preview image. By touching the “add text” button, the user can add desired text to the current image. The edited result is then reflected in real time in the preview image, and the user can obtain his or her desired image by giving an editing instruction. The preview image shown in FIG. 4 is an example in which the user touches the “add text” button to thereby add text “Happy New Year!” to an image of a woman in traditional Japanese kimono.

After giving an editing instruction in this manner, the user touches the “test print” button, and thereby a print (test print) of the currently displayed preview image (e.g., the image of the woman in traditional Japanese kimono, to which the text “Happy New Year!” has been added) is produced. Thus, the “text print” button serves as test-print production instructing means according to an embodiment of the present invention. The user can review a print result, by touching the “test print” button, before the preview image is actually printed.

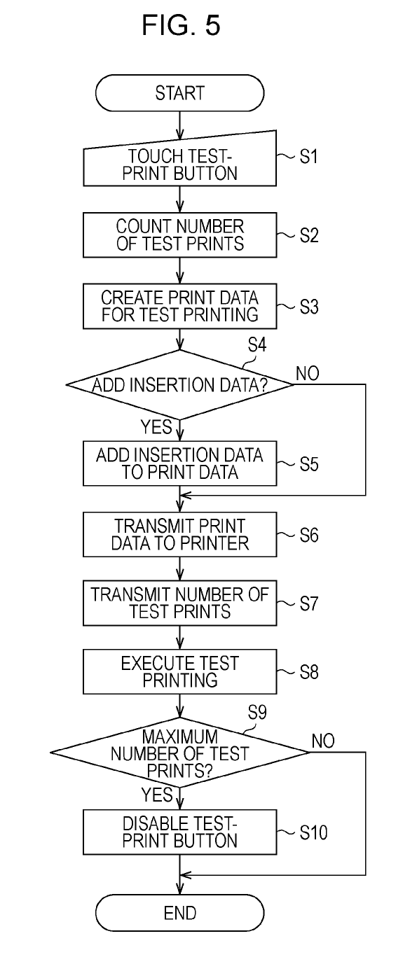

FIG. 5 is a flowchart showing the flow of a printing process for producing a test print using the printing kiosk apparatus 10 of the present embodiment.

As shown in FIG. 5, after the start of the process, in step S1, a user touches the “test print” button to start the production of a test print of a preview image (for example, the image of the woman in traditional Japanese kimono, to which the text “Happy New Year!” has been added, as shown in FIG. 4). In step S2, the number of test prints (in actuality, the number of times the “test print” button has been touched) is counted. The maximum number of test prints allowed to be produced is set in advance using the test-print setting screen shown in FIG. 3.

Then in step S3, print data for producing a test print is created on the basis of editing data or image data necessary for test printing. Then in step S4, it is determined whether or not to add insertion data (which is test-indication data based on image data or text data) for indicating a test print. If the insertion data is to be added, the process proceeds to step S5; if the insertion data is not to be added, the process proceeds to step S6. The determination of whether or not to add the insertion data (whether the setting of the insertion data is turned on or off) is performed in advance using the test-print setting screen shown in FIG. 3.

If it is determined in step S4 that the insertion data is to be added, then in step S5, the insertion data (for example, text data “SAMPLE”, which is set in advance using the test-print setting screen shown in FIG. 3) is added to the print data created in step S3. After the addition of the insertion data in step S5, then in step S6, the resulting print data is transmitted to the printer 40 (see FIG. 1). Also when it is determined in step S4 that the insertion data is to be not added, the print data is transmitted to the printer 40 (see FIG. 1). Then in step S7, information on the number of test prints is transmitted. The number of test prints to be produced per operation is set in advance using the test-print setting screen shown in FIG. 3.

When the print data and the information on the number of prints are transmitted to the printer 40 (see FIG. 1) in this manner, then in step S8, a number of test prints corresponding to the set number of prints are produced. Then in step S9, it is determined whether or not the maximum number of test prints has been reached. If the maximum number of test prints has been reached, the process proceeds to step S10, in which the “test print” button is disabled so as not to produce a further test print. Then, the process ends. If the maximum number of test prints has not been reached yet, the process skips step S10 (the “test print” button is still enabled). The determination of step S9 is performed by comparing the number counted in step S2 with the maximum number set in advance using the test-print setting screen shown in FIG. 3.

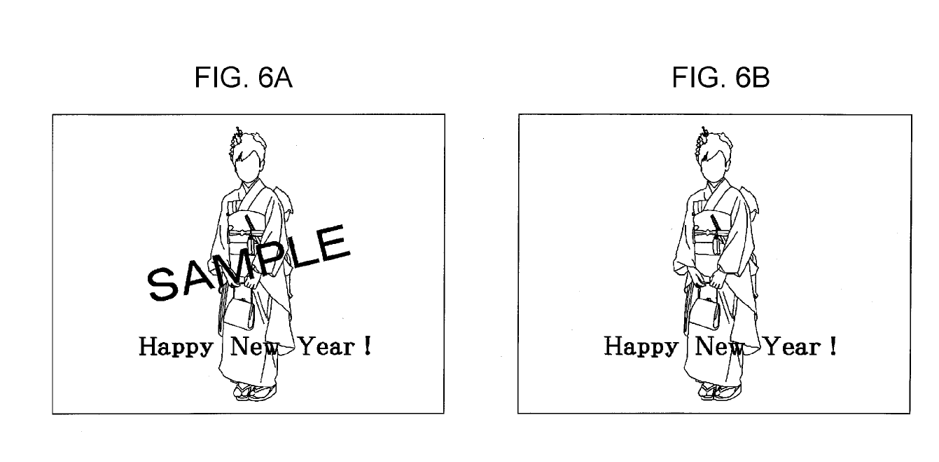

FIGS. 6A and 6B are diagrams showing print results obtained by the printing kiosk apparatus 10 of the present embodiment. FIG. 6A shows a test print, and FIG. 6B shows a normal print.

The print results shown in FIGS. 6A and 6B are obtained by actually printing the preview image shown in FIG. 4 (i.e., the image of the woman in traditional Japanese kimono, to which the text “Happy New Year!” has been added).

The test print shown in FIG. 6A is different from the normal print shown in FIG. 6B in that the text “Happy New Year!” and text “SAMPLE” are added to the image of the woman in traditional Japanese kimono. The text “SAMPLE” is automatically (or forcibly) added by the test-indication adding unit of the control unit shown in FIG. 2 when the user touches the “test print” button shown in FIG. 4. FIG. 6A shows a test print obtained by executing the printing process shown in FIG. 5. The addition of the text “SAMPLE” indicates that the print is a test print. The text “SAMPLE” has a color and size so as not to bother the user in actually reviewing the print result, and the settings of the text “SAMPLE” are determined by the owner of the printing kiosk apparatus 10 using the test-print setting screen shown in FIG. 3.

The execution of such test printing is allowed up to the maximum number set in advance using the test-print setting screen shown in FIG. 3. The user can use the set maximum number of test prints (until the “test print” button does not function) to determine whether or not the desired print result would be obtained. When the user is satisfied with a test print result, then the user executes normal printing to obtain the print shown in FIG. 6B to which the text “SAMPLE” is not added.

Accordingly, the production of a test print of an image allows the user to review a print result before the image is actually printed. By reviewing the print result, the user can obtain his or her most desired print, which might not be obtained by viewing only a preview image. For example, in the case of placing an order of a package of ten prints, the user might unexpectedly obtain ten undesired prints if no test prints are executed. Reviewing print results in advance using test prints would eliminate the risk that all prints ordered will be undesired ones.

Furthermore, a print undesired by the user might lead to the possibility that the owner of the printing kiosk apparatus 10 may refund the price of such an undesired print, which has been paid by the user. In this case, the printing cost of normal prints, as well as a reimbursement of the order placed by the user, may be incurred as losses. With the execution of test printing, the owner can incur only the cost of a minimum investment within an expectable range that is to be generated by producing test prints (i.e., the printing cost of the test prints). Therefore, losses incurred by the owner can be reduced to minimum.

It should be understood by those skilled in the art that various modifications, combinations, sub-combinations and alterations may occur depending on design requirements and other factors insofar as they are within the scope of the appended claims or the equivalents thereof.

What is claimed is:

1. An image forming apparatus comprising:
image data reading means for reading image data stored in a storage medium;
image forming means capable of forming an image on a recording medium on the basis of the image data read by the image data reading means;
billing information generating means for charging a fee for the number of images that have been formed by the image forming means;
test-indication adding means for adding test-indication data indicating a test image to the image data read by the image data reading means; and
test-print production instructing means for instructing the image forming means to form a test image on the basis of the image data to which the test-indication data has been added by the test-indication adding means,
wherein the billing information generating means is configured to charge no fee when a test image is formed in response to an instruction provided by the test-print production instructing means.

2. The image forming apparatus according to claim 1, wherein the billing information generating means does not generate billing information for charging a fee when a test image is formed according to an instruction provided by the test-print production instructing means.

3. The image forming apparatus according to claim 1, wherein the billing information generating means generates billing information indicating a free-of-charge service when a test image is formed according to an instruction provided by the test-print production instructing means.

4. The image forming apparatus according to claim 1, wherein the billing information generating means generates billing information for charging a fee when an image based on image data to which the test-indication data is not added by the test-indication adding means is formed.

5. The image forming apparatus according to claim 1, further comprising image displaying means capable of displaying the image data read by the image data reading means,
wherein the image displaying means displays the number of test images that have been formed by the image forming means.

6. The image forming apparatus according to claim 1, further comprising:
image displaying means capable of displaying the image data read by the image data reading means; and
number-of-test-prints storage means for storing the number of instructions that have been provided by the test-print production instructing means to form a test image,
wherein the image displaying means displays a remaining number of test images, the remaining number being determined by subtracting the number of test images that have been formed by the image forming means from the number of instructions stored in the number-of-test-prints storage means.

7. The image forming apparatus according to claim 1, further comprising test-print production setting means for setting a maximum number of test images to be formed by the image forming means,
wherein an instruction provided by the test-print production instructing means to form a test image is disabled when the number of test images that have been formed by the image forming means has reached the maximum number of test images set by the test-print production setting means.

8. The image forming apparatus according to claim 1, further comprising image processing means for performing image processing on the image data read by the image data reading means.

9. The image forming apparatus according to claim 1, further comprising test-indication-position setting means for setting a position at which the test-indication data is to be added by the test-indication adding means to the image data read by the image data reading means.

10. An image forming apparatus comprising:
an image data reading unit configured to read image data stored in a storage medium;
an image forming unit capable of forming an image on a recording medium on the basis of the image data read by the image data reading unit;
a billing information generating unit configured to charging a fee for the number of images that have been formed by the image forming unit;
a test-indication adding unit configured to add test-indication data indicating a test image to the image data read by the image data reading unit; and
a test-print production instructing unit configured to instruct the image forming unit to form a test image on the basis of the image data to which the test-indication data has been added by the test-indication adding unit,
wherein the billing information generating unit is configured to charge no fee when a test image is formed in response to an instruction provided by the test-print production instructing unit.
